(19) United States
(12) Patent Application Publication
(10) Pub. No.: US 2026/0063301 A1
(43) Pub. Date: Mar. 5, 2026

(54) MULTIFUNCTIONAL GAS BURNER AND GAS STOVE

(71) Applicant: FOSHAN SHUNDE DISTRICT HUNTASTE ELECTRICAL APPLIANCE CO., LTD, Foshan (CN)

(72) Inventors: Jieqiang WEN, Foshan (CN); yiding CAO, Foshan (CN)

(21) Appl. No.: 19/383,318

(22) Filed: Nov. 7, 2025

Related U.S. Application Data
(63) Continuation of application No. PCT/CN2024/083751, filed on Mar. 26, 2024.

(30) Foreign Application Priority Data
May 8, 2023 (CN) 2023210902656

(51) Int. Cl. F24C 3/00; F17C 13/04

(52) U.S. Cl. CPC F24C 3/008; F17C 13/04; F17C 2221/035

(57) ABSTRACT

Disclosed are a multifunctional gas burner and a gas stove. The multifunctional gas burner comprises a base, a device box, a pressure stabilizing valve, a gas valve, a seat frame, a combustor, a nozzle, a support and a supporting base. The seat frame comprises a longitudinal part and a fork frame, opposite hinge sleeves are arranged at two ends of the fork frame, and the nozzles are arranged in one or both of the hinge sleeves; two cylindrical hinge seats are arranged on the combustor, and the cylindrical hinge seats extend into a combustion chamber to form injection pipes; one or both of the cylindrical hinge seats are communicated with a gas cavity of the combustor; the pressure stabilizing valve and the gas valve are arranged in the device box, and the gas valve is communicated with the nozzle by a gas guide pipe.

### REFERENCE TO RELATED APPLICATION

The present disclosure claims priority of Chinese application number 2023210902656 entitled ‘Multifunctional Gas Burner and Gas Stove’ submitted to China National Intellectual Property Administration on May 8, 2023, the entire contents of which are incorporated into the present disclosure by reference.

### TECHNICAL FIELD

The present disclosure generally relates to the field of heating devices, and more particularly to a multifunctional gas burner and a gas stove.

### BACKGROUND OF THE PRESENT INVENTION

The related art discloses a gas stove with a turnable combustor, which comprises a combustor and a bottom shell, wherein one side of the bottom shell is provided with a combustor fixing seat, the combustor is rotatably connected to the combustor fixing seat, the combustor fixing seat is provided with a gas control device, the combustor is provided with a gas safety device, and after the gas safety device determines that the combustor is rotated in place, the gas control device starts gas intake and the combustor starts ignition and combustion.

The related art discloses a multifunctional portable butane gas stove, which comprises a stove body and a fire distributor, wherein one side of the stove body is provided with a connector, the connector is connected with the stove body, one side of the connector is provided with a protective pipe, the protective pipe is connected with the stove body, one side of the protective tube is provided with a fixing head, the fixing head makes contact with the stove body, a bottom part of the stove body is provided with supporting legs, the supporting legs are connected with the stove body, a connecting disc is arranged between the supporting legs, and the connecting plate is connected with the stove body. A pot is placed on the stove for stewing, or a pan is placed on the stove for frying.

### SUMMARY OF THE PRESENT INVENTION

In one aspect, the present disclosure relates to a multifunctional gas burner, which comprises a base, a device box, a pressure stabilizing valve, a gas valve, a seat frame, a combustor, a nozzle, a support and a supporting base,
wherein the seat frame comprises a longitudinal part and a fork frame, opposite hinge sleeves are arranged at two ends of the fork frame, and the nozzles are arranged in one or both of the hinge sleeves;
two cylindrical hinge seats are arranged on the combustor, and the cylindrical hinge seats extend into a combustion chamber to form injection pipes; one or both of the cylindrical hinge seats are communicated with a gas cavity of the combustor; and
the pressure stabilizing valve and the gas valve are arranged in the device box, the longitudinal part is fixedly connected to the device box, and the gas valve is communicated with the nozzle by a gas guide pipe; the cylindrical hinge seats are inserted into the hinge sleeves to be rotatably matched and positioned, and the support is arranged at a top part of the combustor; the base is movably matched with the longitudinal part and positioned; the base and the device box are in supporting fit with a supporting surface; in a stewing state, a combustion end of the combustor faces upwards; in a heating state, the combustion end of the combustor faces a suspended end of the base; and in a grilling and frying state, the combustion end of the combustor faces downwards and is opposite to the base, and an upper surface of the base serves as a grilling and frying surface.

In some embodiments, the multifunctional gas burner comprises an ignition needle and an ignition combustion tube, wherein the ignition needle and the ignition combustion tube are arranged at one end of the fork frame and extend out.

In some embodiments, the cylindrical hinge seat is provided with three radial positioning grooves distributed on a semicircle; and
the fork frame is provided with a guide cavity and communicated with the hinge sleeve, and the guide cavity is provided with a guide hole; and
further comprises a spring, a guide rod and a positioning member, wherein the positioning member comprises a clamping plate, a body part and an operating part,
the body part is located in the guide cavity, the clamping plate is located in the hinge sleeve, the spring is arranged in the guide cavity, and the guide rod penetrates through the spring and the guide hole in the body part and is fixed at two ends of the guide cavity; and the clamping plate is matched with the radial positioning groove.

In some embodiments, the multifunctional gas burner further comprises a circular-arc energy gathering cover, wherein the circular-arc energy gathering cover is matched with the base and the combustion end of the combustor.

In some embodiments, the combustor comprises a base, a burner head, an infrared combustion plate and a fixing sleeve,
the fixing sleeve comprises an insertion cavity arranged at a lower end and a connecting sleeve arranged at an upper end, and the connecting sleeve is provided with a circular-arc groove part and a convex part;
the burner head comprises the cylindrical hinge seats, a central gas inlet cavity, an outer ring gas inlet cavity surrounding the central gas inlet cavity and a counter bore arranged at an upper end, wherein one cylindrical hinge seat is communicated with the central gas inlet cavity and the other cylindrical hinge seat is communicated with the outer ring gas inlet cavity; and
the burner head is arranged on the base, and the infrared combustion plate is embedded with the counter bore and covers upper ends of the central gas inlet cavity and the outer ring gas inlet cavity; and the infrared combustion plate and the burner head are inserted into the insertion cavity and fixed, and the support is fixed with the connecting sleeve.

In some embodiments, the central gas inlet cavity is eccentric relative to the outer ring gas inlet cavity.

In some embodiments, the fixing sleeve is provided with a supporting plate located on the convex part; and
the support comprises an annular seat, a net body or a microcrystalline plate,
the annular seat comprises an annular seat plate, a counter bore arranged at a lower end of the annular seat plate and a sleeve, and
the net body or the microcrystalline plate is arranged in the counter bore, the fixing sleeve is inserted into the sleeve, and the supporting plate supports the net body or the microcrystalline plate.

In some embodiments, an upper surface of the base is provided with a positioning hole; and
a positioning column is arranged on the base, and the positioning column is embedded with the positioning hole.

In some embodiments, the device box comprises an upper opening, a bottom box with an opening at one end and a box cover;
the seat frame comprises an upper half seat frame and a lower half seat frame;
the upper half seat frame comprises an upper half fork frame with a lower opening, an upper half hinge sleeve and an outer longitudinal circular-arc shell, and
the lower half seat frame comprises a lower half fork frame with an upper opening, a lower half hinge sleeve and an inner longitudinal circular-arc plate; and
the outer longitudinal circular-arc shell is connected with one end of the box cover, and the upper half seat frame and the box cover are integrally formed; and the upper half seat frame and the lower half seat frame are fastened and fixed, the upper half fork frame and the lower half fork frame form the fork frame, the upper half hinge sleeve and the lower half hinge sleeve are fastened, the inner longitudinal circular-arc plate is attached to the outer longitudinal circular-arc shell, and the box cover and the bottom box are fastened and fixed.

In some embodiments, the lower half fork frame is provided with a guide cavity and communicated with the lower half hinge sleeve, and the guide cavity is provided with a guide hole;
the cylindrical hinge seat is provided with three radial positioning grooves distributed on a semicircle; and
further comprises a spring, a guide rod and a positioning member, wherein the positioning member comprises a clamping plate, a body part and an operating part,
the body part is located in the guide cavity, the clamping plate is located in the hinge sleeve, the spring is arranged in the guide cavity, and the guide rod penetrates through the spring and the guide hole in the body part and is fixed at two ends of the guide cavity; and the clamping plate is matched with the radial groove.

In some embodiments, the inner longitudinal circular-arc plate is provided with two insertion cavities with lower openings, a longitudinal rod hole and a positioning headstock;
the outer longitudinal circular-arc shell is provided with a button hole;
the base comprises a seat body with an upper opening, two circular-arc plates arranged on the seat body, a positioning rod and a grilling and frying plate, wherein the positioning rod is provided with a plurality of annular positioning grooves; and
further comprises a pressure spring and a lever, wherein the lever comprises a button arranged at an upper end, two half shafts arranged at a middle part and a positioning head arranged at a lower end; and
the circular-arc plate is inserted into the insertion cavity with the lower opening, and the positioning rod is matched with the longitudinal rod hole; the half shafts are hinged with a half shaft seat on the longitudinal circular-arc plate, and the positioning head is in sliding fit with the positioning head seat and extends into the longitudinal rod hole to be matched with the annular positioning groove; the pressure spring is matched with the inner longitudinal circular-arc plate and an upper end of the lever, and the button is matched with the button hole; and a clamping groove of the grilling and frying plate is embedded with the inner longitudinal circular-arc plate and fastened with the seat body.

In some embodiments, the pressure stabilizing valve is provided with a tank interface; and the device box is provided with two guide holes; and
further comprises a butane gas tank and a tank seat frame,
the tank seat frame comprises a frame-shaped support with an upper opening and a supporting rod,
the supporting rods are slidably matched with the guide holes, the butane gas tank is detachably matched with the tank interface, and the frame-shaped support carries the butane gas tank.

In some embodiments, the pressure stabilizing valve is provided with a gas inlet interface; and the device box is provided with two guide holes; and
further comprises the butane gas tank, the tank seat frame and a tank interface seat, and
the tank seat frame comprises a transverse supporting part and a supporting rod, wherein the transverse supporting part is provided with two circular-arc supporting grooves; and
the supporting rods are fixed with two ends of the transverse supporting part, the supporting rods are in sliding fit with the guide holes, the tank interface seat is communicated with the gas inlet interface, the butane gas tank is detachably matched with the tank interface on the tank interface seat, and the circular-arc supporting grooves carry the butane gas tank.

In the other aspect, the present disclosure relates to a gas stove, which comprises a bottom shell, a glass panel and the multifunctional gas burner according to the present disclosure.

In some embodiments, according to the multifunctional gas burner of the present disclosure, the combustor may be rotated and switched in posture, which facilitates switching for different uses.

### DESCRIPTION OF THE DRAWINGS

FIG. 1 is a sectional view of a multifunctional gas burner in one embodiment of the present disclosure.

FIG. 2 is an A-A view of FIG. 1.

FIG. 3 is a B-B view of FIG. 2.

FIG. 4 is a first stereoscopic exploded view of the multifunctional gas burner in one embodiment of the present disclosure.

FIG. 5 is a second stereoscopic exploded view of the multifunctional gas burner in one embodiment of the present disclosure.

FIG. 6 is a third stereoscopic exploded view of the multifunctional gas burner in one embodiment of the present disclosure.

FIG. 7 is a fourth stereoscopic exploded view of the multifunctional gas burner in one embodiment of the present disclosure.

FIG. 8 is a stereoscopic diagram of the multifunctional gas burner in one embodiment of the present disclosure in a first state.

FIG. 9 is a stereoscopic diagram of the multifunctional gas burner in one embodiment of the present disclosure in a second state.

FIG. 10 is a stereoscopic diagram of the multifunctional gas burner in one embodiment of the present disclosure in a third state.

FIG. 11 is a stereoscopic exploded view of the multifunctional gas burner in one embodiment of the present disclosure in the third state.

FIG. 12 is a stereoscopic diagram of the multifunctional gas burner in one embodiment of the present disclosure in a second implementation mode.

FIG. 13 is a stereoscopic exploded view of the multifunctional gas burner in one embodiment of the present disclosure in the second implementation mode.

FIG. 14 is a first stereoscopic diagram of the multifunctional gas burner in one embodiment of the present disclosure in a third implementation mode.

FIG. 15 is a second stereoscopic diagram of the multifunctional gas burner in one embodiment of the present disclosure in the third implementation mode.

### DETAILED DESCRIPTION OF PREFERRED EMBODIMENTS

Embodiments of the present disclosure are described hereinafter in detail, and illustrations of the embodiments are shown in the drawings, where identical or similar reference numerals denote identical or similar elements or elements having the same or similar functions. The embodiments described hereinafter with reference to the drawings are exemplary, and are only intended to explain the present disclosure, but should not be understood as limiting the present disclosure.

In the description of the present disclosure, it should be noted that, the terms “installation”, “connected” and “connection” should be understood in a broad sense unless otherwise specified and defined. For example, they may be fixed connection, removable connection or integrated connection; and may be direct connection, or indirect connection through an intermediate medium, and connection inside two elements. The specific meanings of the above terms in the present disclosure may be understood in a specific case by those of ordinary skills in the art.

### Embodiment 1

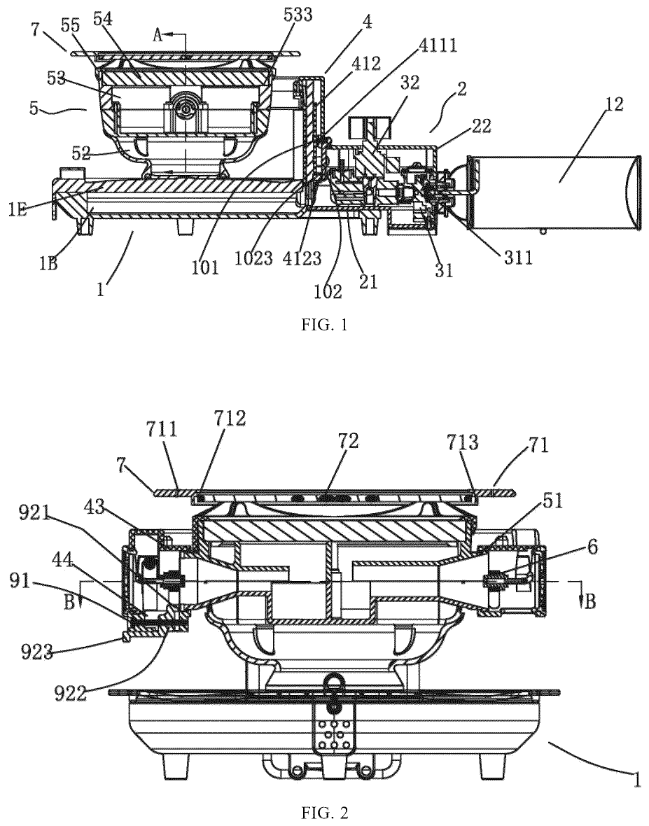

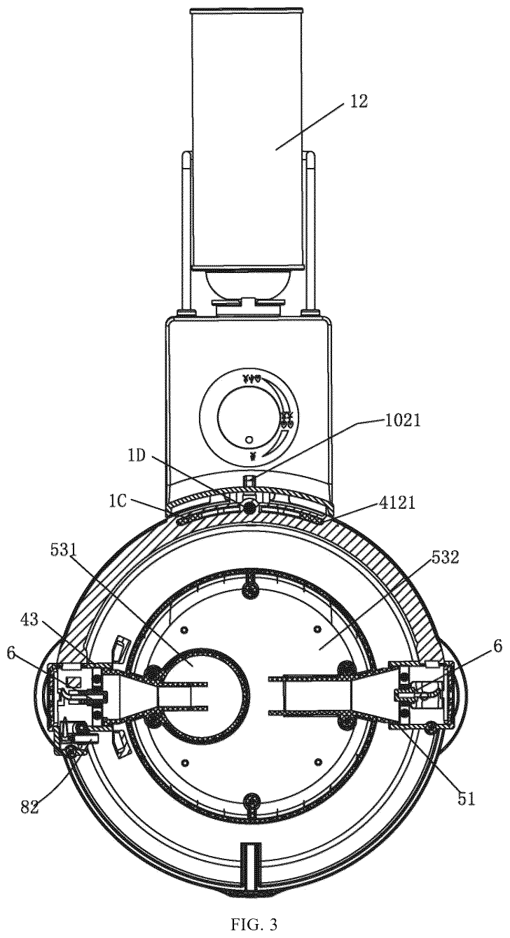

As shown in FIG. 1, a multifunctional gas burner comprises a base 1, a device box 2, a pressure stabilizing valve 31, a gas valve 32, a seat frame 4, a combustor 5, a nozzle 6 and a support 7.

The seat frame 4 comprises a longitudinal part 41 and a fork frame 42, opposite hinge sleeves 43 are arranged at two ends of the fork frame 42, and the fork frame 42 is in a shape of box with an opening at one end, or the fork frame 43 is in a shape of circular arc; an end part of the hinge sleeve 43 is provided with an end cover, and the end cover is provided with a primary air inlet hole group; a nozzle seat is arranged in the hinge sleeve 43, and the nozzle is fixed on the nozzle seat; and the nozzles 6 are arranged in one or both of the hinge sleeves 43.

Two cylindrical hinge seats 51 are arranged on the combustor 5, and the cylindrical hinge seats 51 are hollow and extend into the combustor 5 to form gas and air injection pipes; and one or both of the cylindrical hinge seats 51 are communicated with a gas cavity of the combustor 5.

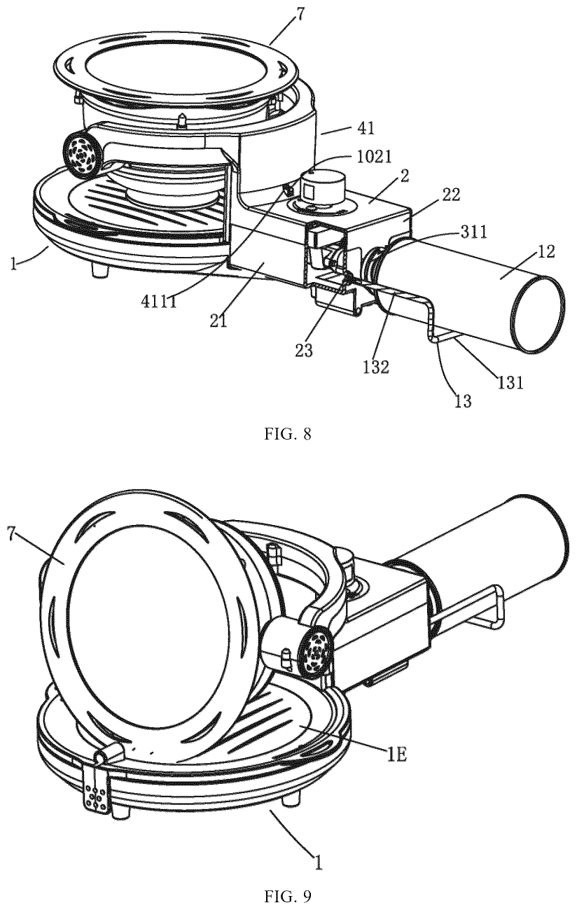

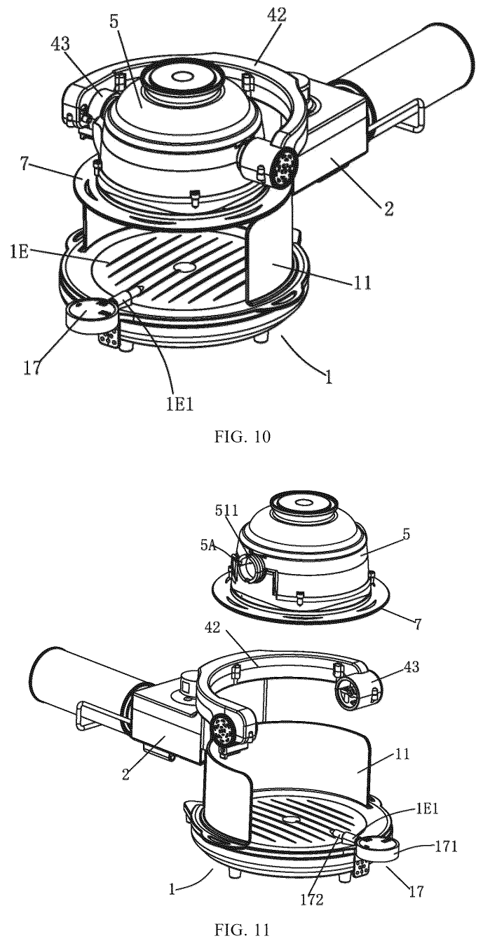

The pressure stabilizing valve 31 and the gas valve 32 are arranged in the device box 2, the longitudinal part 41 is fixedly connected to the device box 2, and the gas valve 32 is communicated with the nozzle 6 by a gas guide pipe; the cylindrical hinge seats 51 are inserted into the hinge sleeves 43 to be rotatably matched and positioned, and the support 7 is arranged at a top part of the combustor 5; the base 1 is movably matched with the longitudinal part 41 and positioned; the base 1 and the device box 2 are in supporting fit with a supporting surface; as shown in FIG. 1 and FIG. 8, in a stewing state, a combustion end of the combustor 5 faces upwards, and a pot or a kettle is placed on the support 7; as shown in FIG. 9, in a heating state, the combustion end of the combustor 5 faces a suspended end of the base 1, and the base 1 carries the support 7; and as shown in FIG. 10 and FIG. 11, in a grilling and frying state, the combustion end of the combustor 5 faces downwards and is opposite to the base 1, and an upper surface of the base 1 serves as a grilling and frying surface.

When switching between the stewing state, the heating state and the grilling and frying state, it is only necessary to rotate the combustor 5, and the support 7 is rotated with the combustor 5.

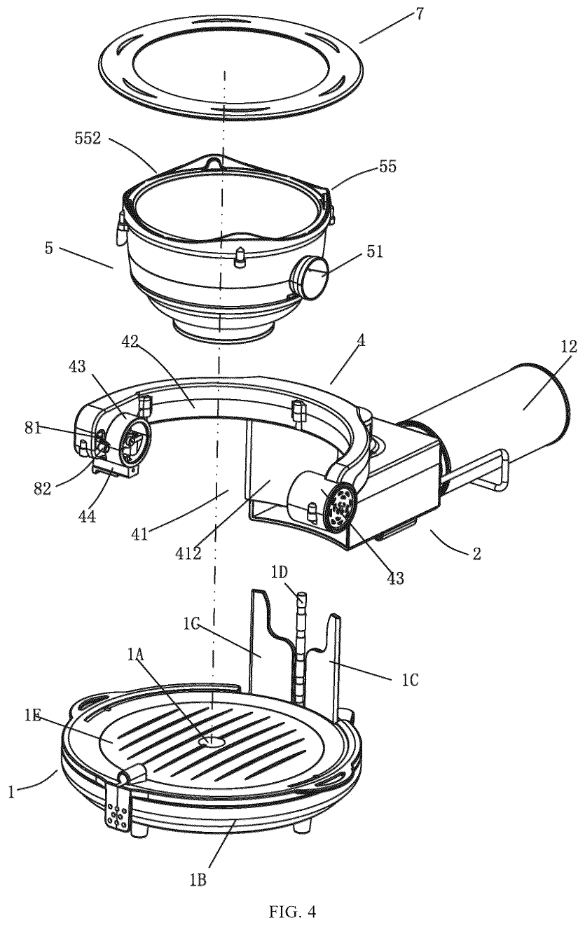

In some embodiments, as shown in FIG. 3 and FIG. 4, the multifunctional gas burner comprises an ignition needle 81 and an ignition combustion tube 82, wherein the ignition needle 81 and the ignition combustion tube 82 are arranged at one end of the fork frame 42 and extend out; and the ignition combustion tube 82 is adjacent to the hinge sleeve 43.

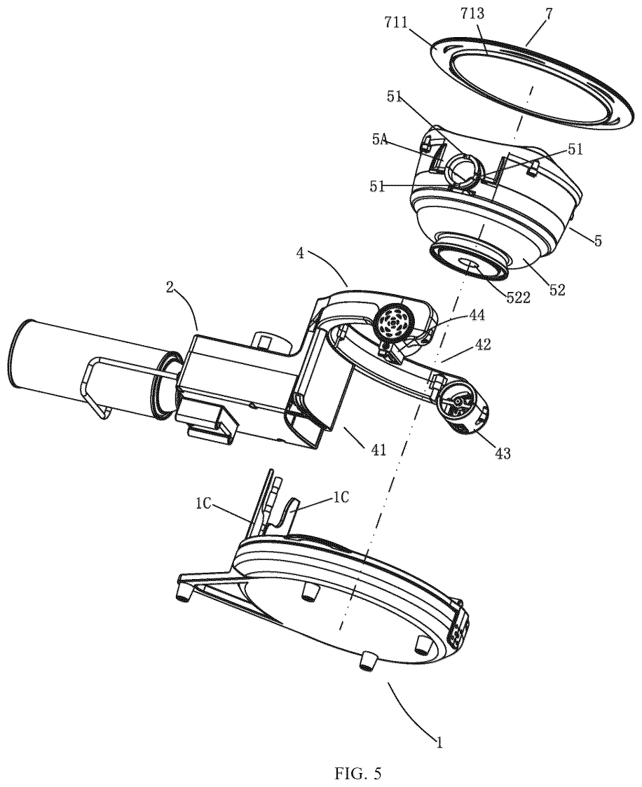

As shown in FIG. 5, the combustor 5 is provided with an ignition slot 5A with a side opening and an upper opening, the ignition combustion tube 82 is opposite to the ignition slot 5A, and the ignition combustion tube 82 is extinguished after the combustor 5 is ignited.

In some embodiments, as shown in FIG. 5, the cylindrical hinge seat 51 is provided with three radial positioning grooves 511 distributed on a semicircle; two radial positioning grooves 511 are on one diameter line; in states as shown in FIG. 1, FIG. 5 and FIG. 8, an upper radial positioning groove 511 is a positioning groove in the stewing state, a lower radial positioning groove 511 is a positioning groove in the grilling and frying state, and a middle radial positioning groove 511 is a positioning groove in the heating state; and a central angle between the positioning groove in the stewing state and the positioning groove in the heating state may be 60 degrees or 90 degrees.

The fork frame 42 is provided with a guide cavity 44 and communicated with the hinge sleeve 43, and the guide cavity 44 is provided with a guide hole; and
further comprises a spring (not shown in the drawings), a guide rod 91 and a positioning member, wherein the positioning member comprises a clamping plate 921, a body part 922 and an operating part 923.

The body part 922 is located in the guide cavity 44, the clamping plate 921 is located in the hinge sleeve 43, the spring is arranged in the guide cavity 44 and extends into the guide hole in a bottom part of the guide cavity, the operating part 923 is located outside the guide cavity 44, and the guide rod 91 penetrates through the spring and the guide hole in the body part 922 and is fixed at two ends of the guide cavity; and the clamping plate 921 is matched with the radial positioning groove 511.

The combustor 5 comprises a base 52, a burner head 53, an infrared combustion plate 54 and a fixing sleeve 55.

The fixing sleeve 55 comprises an insertion cavity 551 arranged at a lower end and a connecting sleeve 552 arranged at an upper end, the connecting sleeve 552 is provided with a circular-arc groove part and a convex part, the circular-arc groove part and the convex part are arranged at an interval, and the circular-arc groove part is used as a secondary air channel.

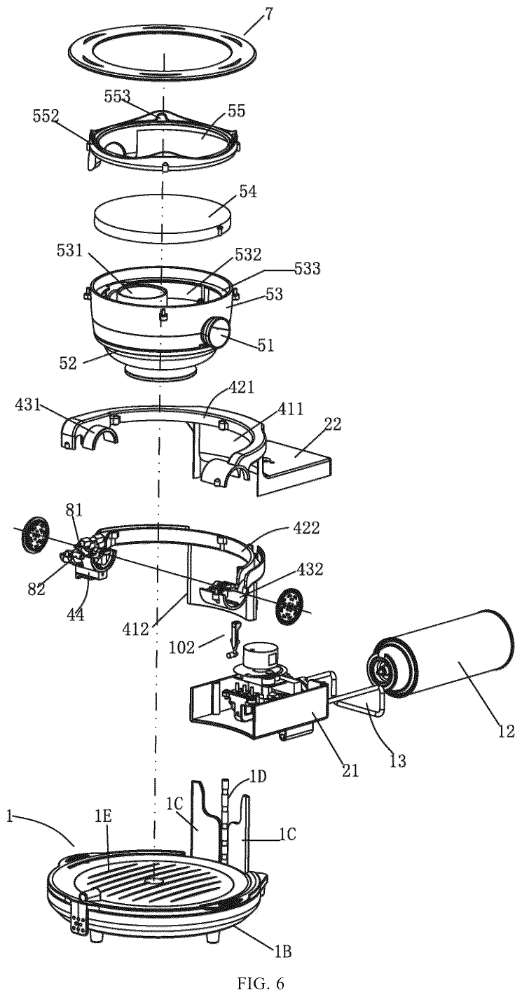

As shown in FIG. 3 and FIG. 6, the burner head 53 comprises the cylindrical hinge seats 51, a central gas inlet cavity 531, an outer ring gas inlet cavity 532 surrounding the central gas inlet cavity and a counter bore 533 arranged at an upper end, wherein one cylindrical hinge seat 51 is communicated with the central gas inlet cavity 531 and the other cylindrical hinge seat 51 is communicated with the outer ring gas inlet cavity 532.

The burner head 53 is arranged on the base 52 and fixedly connected with the base, and the infrared combustion plate 54 is embedded with the counter bore 533 and covers upper ends of the central gas inlet cavity 531 and the outer ring gas inlet cavity 532; and the infrared combustion plate 54 and the burner head 53 are inserted into the insertion cavity 551 and fixed, and the support 7 is fixed with the connecting sleeve 552.

As shown in FIG. 3, the central gas inlet cavity is cylindrical, and the central gas inlet cavity is eccentric relative to the outer ring gas inlet cavity.

The fixing sleeve 55 is provided with a supporting plate 553 located on a radial inner side of the convex part.

The support 7 comprises an annular seat 71, a net body or a microcrystalline plate 72.

The annular seat 71 comprises an annular seat plate 711, a counter bore 712 arranged at a lower end of the annular seat plate and a sleeve 713.

The net body or the microcrystalline plate 72 is arranged in the counter bore 712, the fixing sleeve 55 is inserted into the sleeve 713, and the supporting plate 553 supports the net body or the microcrystalline plate 72.

In some embodiments, an upper surface of the base 1 is provided with a positioning protrusion 1A.

A positioning hole 521 is arranged in the base 52, and the positioning protrusion 1A is embedded with the positioning hole 521, as shown in FIG. 1.

In some embodiments, the device box 2 comprises an upper opening, a bottom box 21 with an opening at one end and a box cover 22.

The seat frame 4 comprises an upper half seat frame and a lower half seat frame.

The upper half seat frame comprises an upper half fork frame 421 with a lower opening, an upper half hinge sleeve 431 and an outer longitudinal circular-arc shell 411; and the upper half fork frame 421 is hollow, provided with a lower opening, and is communicated with the upper half hinge sleeve 431 and the outer longitudinal circular-arc shell 411.

The lower half seat frame 4 comprises a lower half fork frame 422 with an upper opening, a lower half hinge sleeve 432 and an inner longitudinal circular-arc plate 412; the lower half fork frame 422 is provided with an upper opening and communicated with the lower half hinge sleeve 432; and the guide cavity 44 is arranged on the lower half hinge sleeve 432.

The outer longitudinal circular-arc shell 411 is connected with one end of the box cover 22, and the upper half seat frame and the box cover 22 are integrally formed; and the upper half seat frame 4 and the lower half seat frame 4 are fastened and fixed, the upper half fork frame 421 and the lower half fork frame 422 form the fork frame 42, the upper half hinge sleeve 431 and the lower half hinge sleeve 432 are fastened to form the hinge sleeve 43, the inner longitudinal circular-arc plate 412 is attached to the outer longitudinal circular-arc shell 411 to form the longitudinal part 41, and the box cover 22 and the bottom box 21 are fastened and fixed. The use of such structure facilitates assembling the combustor 5, and a gas conduit enters the outer longitudinal circular-arc shell 411 from the device box, then enters a space formed by the upper half fork frame 421 and the lower half fork frame 422, and finally enters the hinge sleeve 43.

In some embodiments, the inner longitudinal circular-arc plate 412 is provided with two insertion cavities 4121 with lower openings, a longitudinal rod hole 4122 and a positioning headstock 4123; and the longitudinal rod hole 4122 is located between the two insertion cavities 4121 with lower openings.

The outer longitudinal circular-arc shell 411 is provided with a button hole 4111.

The base 1 comprises a seat body 1B with an upper opening, two circular-arc plates 1C arranged on the seat body 1B, a positioning rod 1D and a grilling and frying plate 1E, wherein the positioning rod 1D is located between the two circular-arc plates 1C, and the positioning rod 1D is provided with a plurality of annular positioning grooves; and
further comprises a pressure spring 101 and a lever 102, wherein the lever 102 comprises a button 1021 arranged at an upper end, two half shafts 1022 arranged at a middle part and a positioning head 1023 arranged at a lower end.

The circular-arc plate 1C is inserted into the insertion cavity 4121 with the lower opening, and the positioning rod 1D is matched with the longitudinal rod hole 4122; the half shafts 1022 are hinged with a half shaft seat on the longitudinal circular-arc plate 412, and the positioning head 1023 is in sliding fit with the positioning head seat 4123 and extends into the longitudinal rod hole 4122 to be matched with the annular positioning groove on the positioning rod 1D; the pressure spring 101 is matched a spring seat of with the inner longitudinal circular-arc plate and a spring seat at an upper end of the lever, and the button 1021 is matched with the button hole 4111; a clamping groove of the grilling and frying plate 1E is embedded with the inner longitudinal circular-arc plate 412 and fastened with the seat body 1B; the grilling and frying plate 1E is detachable; and water is placed on the seat body 1B to prevent heat from being transferred to the supporting surface. The base 1 moves up and down relative to the seat frame 4, or the device box 2, the seat frame 4 and the combustor 5 move up or down together and are positioned.

### Embodiment 2

As shown in FIG. 10 and FIG. 11, the multifunctional gas burner further comprises a circular-arc energy gathering cover 11, wherein the circular-arc energy gathering cover 11 is matched with the base 1 and the combustion end of the combustor 5, and a lower end of the circular-arc energy gathering cover 11 is in supporting fit with the grilling and frying plate 1E.

In some embodiments, the grilling and frying plate 1E is provided with a fixing seat, and further comprises a temperature detection display device 17.

The temperature detection display device 17 comprises a body part 171 and a probe part 172, wherein the body part comprises a temperature display part, a circuit board, a Wifi and a power supply.

The probe part 172 penetrates through the connecting hole in the fixing seat 1E1 and is opposite to the grilling and frying plate 1E; and the temperature detection display device 17 may display a grilling temperature in real time and transmit the grilling temperature to terminals such as a mobile phone.

### Embodiment 3

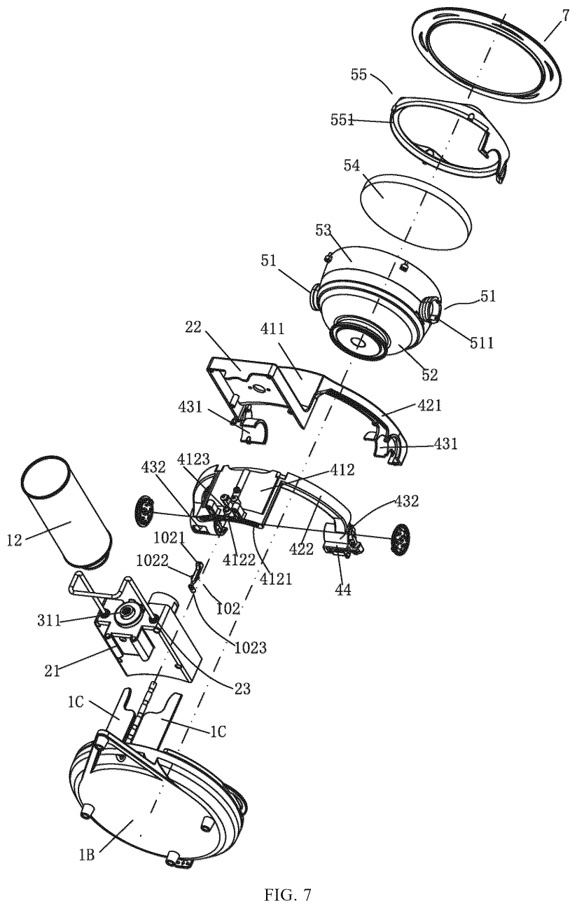

As shown in FIG. 1, FIG. 6 and FIG. 7, the pressure stabilizing valve 31 is provided with a tank interface 311, and the tank interface extends out of the device box 2; and an end plate of the device box 2 is provided with two guide holes 23; and
further comprises a butane gas tank 12 and a tank seat frame 13.

The tank seat frame 13 comprises a frame-shaped support 131 with an upper opening and a supporting rod 132.

The supporting rods 132 are slidably matched with the guide holes 23, the butane gas tank 12 is detachably matched with the tank interface 311, and the frame-shaped support 131 carries the butane gas tank 12. After the butane gas tank 12 is disassembled, the supporting rods 132 retract into the device box 2 to reduce the volume.

### Embodiment 4

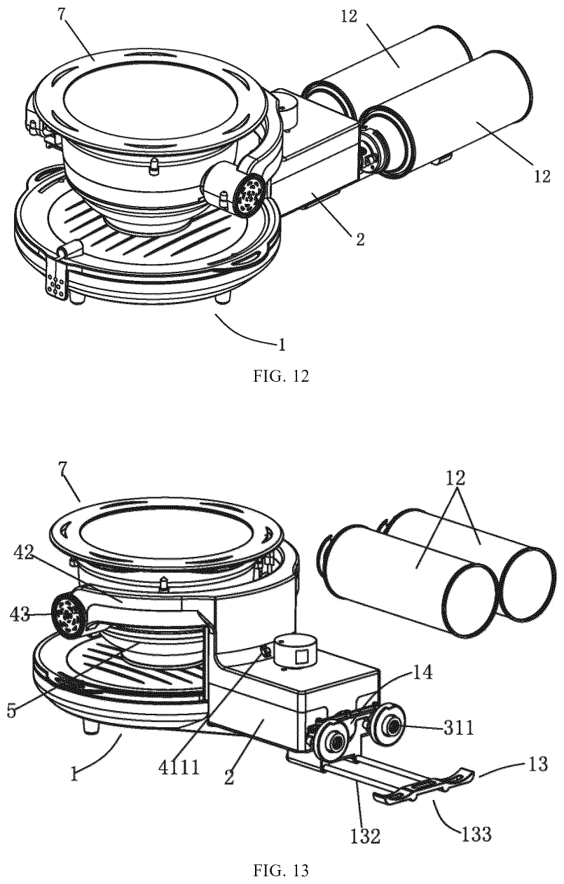

As shown in FIG. 12 and FIG. 13, the pressure stabilizing valve 31 is provided with a gas inlet interface; and the device box is provided with two guide holes; and
further comprises the butane gas tank 12, the tank seat frame 13 and a tank interface seat 14.

The tank seat frame 13 comprises a transverse supporting part 133 and a supporting rod 132, wherein the transverse supporting part 133 is provided with two circular-arc supporting grooves; and
the supporting rods 132 are fixed with two ends of the transverse supporting part 133, the supporting rods 132 are in sliding fit with the guide holes, the tank interface seat 14 is communicated with the gas inlet interface of the pressure stabilizing valve 31, the butane gas tank 12 is detachably matched with the tank interface on the tank interface seat 14, and the circular-arc supporting grooves carry the butane gas tank 12.

### Embodiment 5

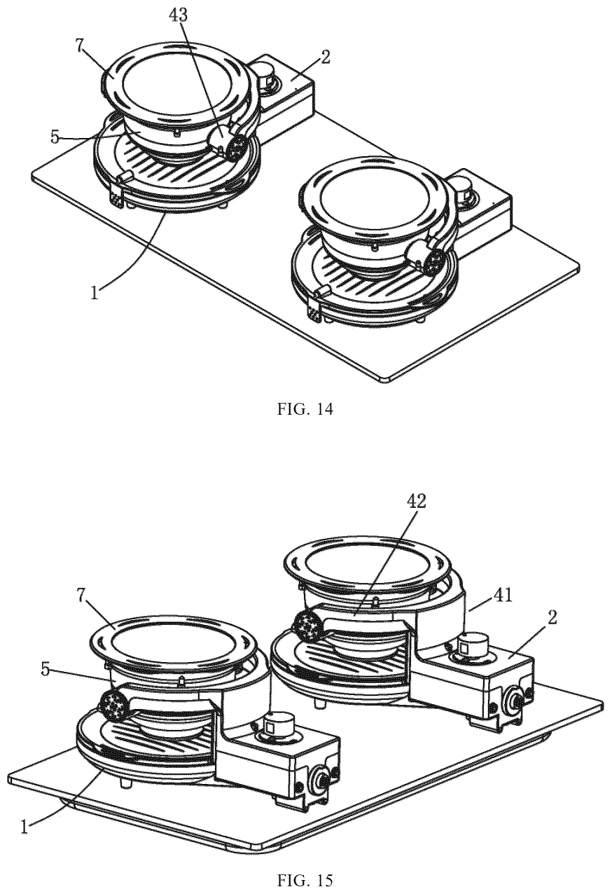

As shown in FIG. 14 and FIG. 15, a gas stove comprises a bottom shell 15, a glass panel 16 and the multifunctional gas burner above. The pressure stabilizing valve 31 of the multifunctional gas burner is communicated with a natural gas pipeline or a liquefied gas tank.

Although the embodiments of the present disclosure have been shown and described, those of ordinary skills in the art should understand that: various changes, amendments, substitutions and modifications can be made to these embodiments without departing from the principles and purposes of the present disclosure, and the scope of the present disclosure is limited by the claims and equivalents thereof.

1. A multifunctional gas burner, comprising a base, a device box, a pressure stabilizing valve, a gas valve, a seat frame, a combustor, a nozzle, a support and a supporting base,
wherein the seat frame comprises a longitudinal part and a fork frame, opposite hinge sleeves are arranged at two ends of the fork frame, and the nozzles are arranged in one or both of the hinge sleeves;
two cylindrical hinge seats are arranged on the combustor, and the cylindrical hinge seats extend into a combustion chamber to form injection pipes; one or both of the cylindrical hinge seats are communicated with a gas cavity of the combustor; and
the pressure stabilizing valve and the gas valve are arranged in the device box, the longitudinal part is fixedly connected to the device box, and the gas valve is communicated with the nozzle by a gas guide pipe; the cylindrical hinge seats are inserted into the hinge sleeves to be rotatably matched and positioned, and the support is arranged at a top part of the combustor; the base is movably matched with the longitudinal part and positioned; the base and the device box are in supporting fit with a supporting surface; in a stewing state, a combustion end of the combustor faces upwards; in a heating state, the combustion end of the combustor faces a suspended end of the base; and in a grilling and frying state, the combustion end of the combustor faces downwards and is opposite to the base, and an upper surface of the base serves as a grilling and frying surface.

2. The multifunctional gas burner according to claim 1, comprising an ignition needle and an ignition combustion tube, wherein the ignition needle and the ignition combustion tube are arranged at one end of the fork frame and extend out.

3. The multifunctional gas burner according to claim 1, wherein the cylindrical hinge seat is provided with three radial positioning grooves distributed on a semicircle;
the fork frame is provided with a guide cavity and communicated with the hinge sleeve, and the guide cavity is provided with a guide hole; and
further comprises a spring, a guide rod and a positioning member, wherein the positioning member comprises a clamping plate, a body part and an operating part,
the body part is located in the guide cavity, the clamping plate is located in the hinge sleeve, the spring is arranged in the guide cavity, and the guide rod penetrates through the spring and the guide hole in the body part and is fixed at two ends of the guide cavity; and the clamping plate is matched with the radial positioning groove.

4. The multifunctional gas burner according to claim 1, further comprising a circular-arc energy gathering cover, wherein the circular-arc energy gathering cover is matched with the base and the combustion end of the combustor.

5. The multifunctional gas burner according to claim 1, wherein the combustor comprises a base, a burner head, an infrared combustion plate and a fixing sleeve,
the fixing sleeve comprises an insertion cavity arranged at a lower end and a connecting sleeve arranged at an upper end, and the connecting sleeve is provided with a circular-arc groove part and a convex part;
the burner head comprises the cylindrical hinge seats, a central gas inlet cavity, an outer ring gas inlet cavity surrounding the central gas inlet cavity and a counter bore arranged at an upper end, wherein one cylindrical hinge seat is communicated with the central gas inlet cavity and the other cylindrical hinge seat is communicated with the outer ring gas inlet cavity; and
the burner head is arranged on the base, and the infrared combustion plate is embedded with the counter bore and covers upper ends of the central gas inlet cavity and the outer ring gas inlet cavity; and the infrared combustion plate and the burner head are inserted into the insertion cavity and fixed, and the support is fixed with the connecting sleeve.

6. The multifunctional gas burner according to claim 5, wherein the fixing sleeve is provided with a supporting plate located on the convex part; and
the support comprises an annular seat, a net body or a microcrystalline plate,
the annular seat comprises an annular seat plate, a counter bore arranged at a lower end of the annular seat plate and a sleeve, and
the net body or the microcrystalline plate is arranged in the counter bore, the fixing sleeve is inserted into the sleeve, and the supporting plate supports the net body or the microcrystalline plate.

7. The multifunctional gas burner according to claim 5, wherein an upper surface of the base is provided with a positioning hole; and
a positioning column is arranged on the base, and the positioning column is embedded with the positioning hole.

8. The multifunctional gas burner according to claim 5, wherein the central gas inlet cavity is eccentric relative to the outer ring gas inlet cavity.

9. The multifunctional gas burner according to claim 1, wherein the device box comprises an upper opening, a bottom box with an opening at one end and a box cover;
the seat frame comprises an upper half seat frame and a lower half seat frame;
the upper half seat frame comprises an upper half fork frame with a lower opening, an upper half hinge sleeve and an outer longitudinal circular-arc shell, and
the lower half seat frame comprises a lower half fork frame with an upper opening, a lower half hinge sleeve and an inner longitudinal circular-arc plate; and
the outer longitudinal circular-arc shell is connected with one end of the box cover, and the upper half seat frame and the box cover are integrally formed; and the upper half seat frame and the lower half seat frame are fastened and fixed, the upper half fork frame and the lower half fork frame form the fork frame, the upper half hinge sleeve and the lower half hinge sleeve are fastened, the inner longitudinal circular-arc plate is attached to the outer longitudinal circular-arc shell, and the box cover and the bottom box are fastened and fixed.

10. The multifunctional gas burner according to claim 9, wherein the lower half fork frame is provided with a guide cavity and communicated with the lower half hinge sleeve, and the guide cavity is provided with a guide hole;
the cylindrical hinge seat is provided with three radial positioning grooves distributed on a semicircle; and
further comprises a spring, a guide rod and a positioning member, wherein the positioning member comprises a clamping plate, a body part and an operating part,
the body part is located in the guide cavity, the clamping plate is located in the hinge sleeve, the spring is arranged in the guide cavity, and the guide rod penetrates through the spring and the guide hole in the body part and is fixed at two ends of the guide cavity; and the clamping plate is matched with the radial groove.

11. The multifunctional gas burner according to claim 9, wherein the inner longitudinal circular-arc plate is provided with two insertion cavities with lower openings, a longitudinal rod hole and a positioning headstock;
the outer longitudinal circular-arc shell is provided with a button hole;
the base comprises a seat body with an upper opening, two circular-arc plates arranged on the seat body, a positioning rod and a grilling and frying plate, wherein the positioning rod is provided with a plurality of annular positioning grooves; and
further comprises a pressure spring and a lever, wherein the lever comprises a button arranged at an upper end, two half shafts arranged at a middle part and a positioning head arranged at a lower end; and
the circular-arc plate is inserted into the insertion cavity with the lower opening, and the positioning rod is matched with the longitudinal rod hole; the half shafts are hinged with a half shaft seat on the longitudinal circular-arc plate, and the positioning head is in sliding fit with the positioning head seat and extends into the longitudinal rod hole to be matched with the annular positioning groove; the pressure spring is matched with the inner longitudinal circular-arc plate and an upper end of the lever, and the button is matched with the button hole; and a clamping groove of the grilling and frying plate is embedded with the inner longitudinal circular-arc plate and fastened with the seat body.

12. The multifunctional gas burner according to claim 1, wherein the pressure stabilizing valve is provided with a tank interface; and the device box is provided with two guide holes; and
further comprises a butane gas tank and a tank seat frame,
the tank seat frame comprises a frame-shaped support with an upper opening and a supporting rod,
the supporting rods are slidably matched with the guide holes, the butane gas tank is detachably matched with the tank interface, and the frame-shaped support carries the butane gas tank.

13. The multifunctional gas burner according to claim 1, wherein the pressure stabilizing valve is provided with a gas inlet interface; and the device box is provided with two guide holes; and
further comprises the butane gas tank, the tank seat frame and a tank interface seat, and
the tank seat frame comprises a transverse supporting part and a supporting rod, wherein the transverse supporting part is provided with two circular-arc supporting grooves; and
the supporting rods are fixed with two ends of the transverse supporting part, the supporting rods are in sliding fit with the guide holes, the tank interface seat is communicated with the gas inlet interface, the butane gas tank is detachably matched with the tank interface on the tank interface seat, and the circular-arc supporting grooves carry the butane gas tank.

14. A gas stove, comprising a bottom shell, a glass panel and the multifunctional gas burner according to claim 1.
